(19) United States
(12) Patent Application Publication
(10) Pub. No.: US 2003/0159304 A1
(43) Pub. Date: Aug. 28, 2003

(54) Compact clip holder marking device attachment for measuring tape

(76) Inventor: Jeremy Black, St. George, UT (US)

Correspondence Address: Jeremy Black, P.O. Box 1263, St. George, UT, 84771, US

(21) Appl. No.: 10/083,460

(22) Filed: Feb. 26, 2002

(51) Int. Cl. B25H 7/00; G01B 3/10

(52) U.S. Cl. 33/668

(57) ABSTRACT

A novel compact clip holder marking device attachment for measuring tape (9) comprising of a one-piece clip holder (10) having a front side (11) having a slotted hole, an interior front (12), a back side (13), an interior back side (14) having a raised area (21), a right side (15), an interior right side (16), a left side (17), an interior left side (18), a top surface opening (19), a bottom surface opening (20), an interior space area (23), a marking element (24) having a marking surface area (25). The said compact marking device (9) may be attached to the end of the measuring tape (26) by pressing the end of said measuring tape (26) downward into said top surface opening (20) of said clip holder (10) causing the end of said measuring tape (26) to be received by the interior space area (23) causing said measuring tape (26) to be held in a fixed position by the said raised area (21) located on said interior back side (14). By applying sufficient pulling force on the one-piece clip holder (10) causing the holding force to break loose allowing the disengagement of the measuring tape (26) from the said marking device (9) the said compact marking device (9) can be used by itself as a marking device (9) marking element may be removed from the one-piece clip holder (10). The compact marking device (9) may be attached to the measuring tape (26) when stored.

### BACKGROUND

1. Field of Invention

This invention relates to a tape measure marking device, in particular to a one-piece clip holder with the ability to hold a marking device such as a piece of chalk, crayon, lead, a pencil, pen, steel tip marker or any other configuration that can be adaptable for use in said one-piece clip holder marking device attached to the end of a measuring tape.

2. Description of Prior Art

Prior art marking devices for measuring tapes are designed to attached to the body of the measuring tape. The difficulties with the prior art marking devices; parties must use the body of the measuring tape which has the marking device attached, whereas, my invention the marking device is attached not to the body of the measuring tape but to the actual end of the tape itself. The prior art is more time consuming in attaching the marking device to the body of the measuring tape.

Another type marking device that has been employed is the type that the attaching device for releasably attaching a marking device to a tape measure having a tape measure housing containing a tape measuring tape which increases the outside dimension of the body of the measuring tape causing the measuring tape to be less user friendly because it's harder to store or fit into a belt pouch etc. Whereas, my invention the marking device is compact and easier to install or remove from the measuring tape. Also, my invention can be used as a separate marking device without being attached to the measuring tape. My invention has an unique feature the marking device is attached to the end of the measuring tape itself not to the body.

Another type marking device having a combination marker and tape measure is very complicated consisting of interconnected parts causing this type marking device to be more costly to manufacture than my invention. What makes this prior art so expensive to manufacture it has a front window cover, bottom cover, a compartment on the front surface of the housing, a plunger knob which is depressed into a recess, a declining front face on the housing, a locking mechanism formed on a plunger which permits selective locking of the tape, a guide foot removably mounted on the end tab enables marking a line parallel to an edge of a surface. My invention has only two parts that makes up the marking device. The one-piece clip holder and a marking element.

Another type marking device for a tape measure is attached to the body of the tape measure. This marking device has multiple parts making the manufacturing much more costly than my compact marking device. My invention is more friendly to use because of its simplistic design. It can be used by itself as a marking device without being attached to the end of the measuring tape.

Another type marking device is attached to the body of the measuring tape having a spring return mechanism and a tape lock, includes a spring clip for attaching the tape to a belt or clothing. The spring clip has two openings, one at the bend of the clip and the second near the free end of the clip to engage the marking device and position it precisely in alignment with the point of exit of the tape from the housing. This prior art costs more to manufacture than my invention.

Another type marking device is a combined tape measure and marking device that includes a housing in which a spool is rotateably supported and on which an elongate tape is wound, a spring-loaded arm is pivotal from one side of the housing. Manually the marking device is aligned with the material being marked. When not marking the arm is released to a second position causing the marking device to be out of contact with the article that is being marked. This prior art marking device has the same common design as all other prior art, the marking device is attached to the body of the tape measure, whereas, my invention attaches to the end of the measuring tape itself. Quick to use and can be used by itself as a marking device.

Another type marking device comprises a housing adapted to be fixed to the tape casing adjacent to the tape-issuing opening, and an operator spring-mounted within the housing. The lower end of the operator carries a marking element adapted, when the operator is depressed, to engage and mark the article being measured; and the side of the operator carries a stop element in the shape of a pointer adapted to engage the tape when the operator is depressed to indicate the length of the issued tape as well as to arrest any further movement of the tape. This prior art is attached to the body of the measuring tape whereas, my invention attaches to the end of the measuring tape itself not to the body of the tape measure.

My invention has only two parts, a compact clip holder and a marking element making up the complete marking device. My invention is different in design and function because it attaches to the end of the tape itself and not to the body of the tape measure, allowing the user to mark any surface which is being measured.

### OBJECTS AND ADVANTAGES

Accordingly, besides the objects and advantages described above, several objects and advantages of the present invention are:

(a) To provide a marking device which has the ability to be permanently attached to the end of the measuring tape.

(b) To provide a marking device which can be used on a measuring tape for marking a flat surface or for marking the circumference of any circular object.

(c) Allowing the use of multiple items used as the marking device permanently held in place by the compact one-piece clip holder on the end of a measuring tape.

(d) Allowing the party to use the compact clip holder marking device separately in his hand without the use of the measuring tape.

(e) To provide a compact marking device which can be carried in a coat or shirt pocket, toolbox or stored in a small area until needed for future use.

It is the feature of my invention that it provides a compact clip holder marking device attached on the end of a measuring tape for marking an object that needs to be marked for whatever reason. This invention comprising of a one-piece body made of applicable material that will allow it to hold a marking element in the manner to mark objects that need to have dimensional marks for assembly, cutting, or any other function.

It is the object of my invention to provide a marking device that is capable of measuring and marking any surface. There is a need in the commercial construction business as well as in the private sector for such a marking device.

Other objects and features are readily apparent from the following description of certain preferred embodiments, thereof taken conjunction with the accompanying drawings, although variations and modifications may be affected without departing from the sphere and the scope of the normal concepts of the disclosed invention. You will find further objects and advantages of the invention from a consideration of the ensuing description and accompanying drawings.

### DRAWING FIGURES

FIG. 1 Shows a perspective view of the marking device in accordance with the invention.

FIG. 2 Shows a top view of the marking device less the marking element and measuring tape in their fixed positions.

FIG. 3 Shows a front view of the marking device with the marking element and measuring tape in their fixed positions.

FIG. 4 Shows a cross-sectional side view, with the marking element and measuring tape in their fixed positions, taken along line 4-4 FIG. 3.

### DRAWING REFERENCE NUMERALS

9 compact marking device

10 one-piece clip holder

11 front side

12 interior front side

13 back side

14 interior back side

15 right side

16 interior right side

17 left side

18 interior left side

19 top surface opening

20 bottom surface opening

21 raised area

22 slotted hole

23 interior space area

24 marking element

25 marking surface area

26 measuring tape

### DESCRIPTION OF INVENTION

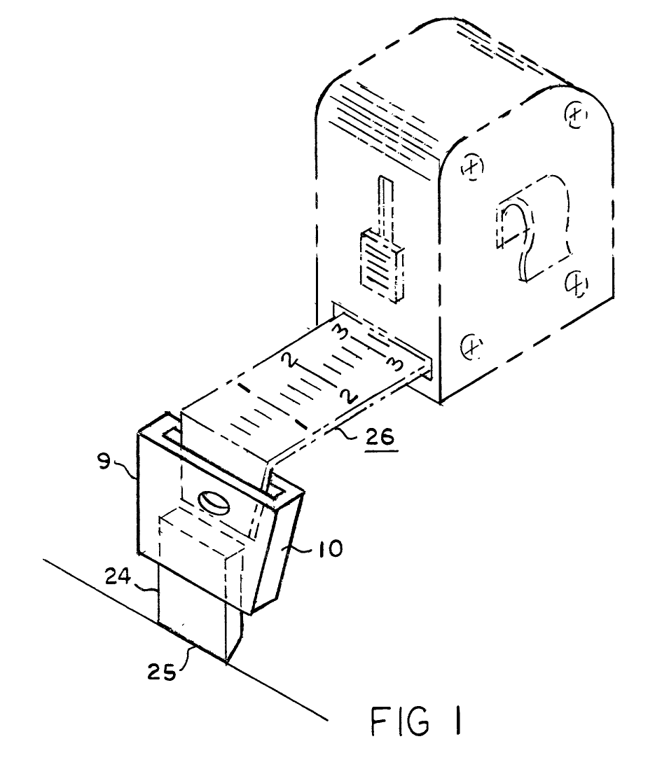

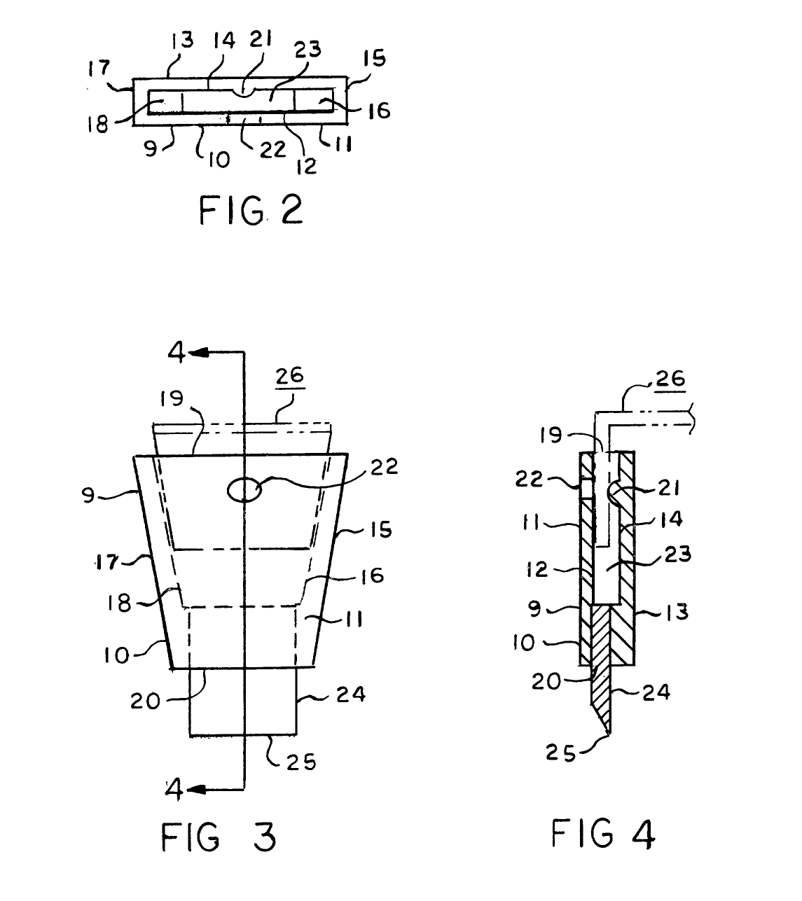

The compact marking device attachment for measuring tape 9 shown in FIG. 1, FIG. 2, FIG. 3 and FIG. 4 comprises of a one-piece clip holder 10, having sufficient thickness, width and length, having the following features: a front side 11, having a slotted hole having sufficient width and length, an interior front side 12, a back side 13, an interior back side 14 having a raised area 21 having sufficient thickness, width and length, a right side 15, an interior right side 16, a left side 17, an interior left side 18, a top surface opening 19, a bottom surface opening 20, an interior space area 23 having sufficient depth, width and length, a marking element 24 having sufficient thickness, width and length having a marking surface area 25 having sufficient width and length. The compact marking device 9 may be attached to the end of the measuring tape 26 by pressing the measuring tape 26 downward into the top surface 20 of the clip holder 10 causing the end of t measuring tape 26 to be received by the interior space area 23 causing the measuring tape 26 to be held in place by the raised area 21 located on the interior back side 14. By applying sufficient pulling force on the one-piece clip holder 10 causing the holding force to break loose allowing the disengagement of the measuring tape 26 from the marking device 9. The compact marking device 9 can be used by itself as a marking device 9 without being attached to the measuring tape 26. The compact marking device 9 can be stored in a coat pocket, shirt pocket, a toolbox or in any storage area until needed for future use. The compact marking device 9 may be attached to the measuring tape 26 when stored.

### CONCLUSION AND SCOPE OF INVENTION

Accordingly, the reader will see that the compact clip holder marking device attachment for measuring tape has the ability to be used to mark any object surface needing to be marked for cutting, assembly, etc. Furthermore, the measuring device has the additional advantages in that:

It provides the ability for the marking device to be used as a separate marking device.

It permits the one-piece clip holder to be attached to the tape of a measuring tape allowing the end of the tape to be used to mark any object.

It permits the one-piece clip holder quick removal from the measuring tape when needed.

It allows the marking device to be used on multiple measuring tapes.

It allows the user to mark any surface at ease.

Although the description above contains many specifications, these should not be construed as limiting the scope of the invention but merely providing illustrations of some of the presently preferred embodiments of this invention. For example, the marking device one-piece clip holder shape can have other shapes, such as square, oval, trapezoidal, triangular, etc. The marking device can be of different combinations such as fabric, plastic, metal, steel, aluminum, wood, etc.

Thus, the scope of the invention should be determined by the appended claims and their legal equivalents, rather than by the examples given.

I claim as my invention:

1. A compact clip holder marking device attachment for measuring tape which comprises: a one-piece clip holder having sufficient thickness, width, and length having a front side having a slotted hole having sufficient width and length, an interior front side, a back side, an interior back side, having a raised area having sufficient thickness, width and length, a right side, an interior right side, a left side, an interior left side, a top surface opening, a bottom surface opening, an interior space area having sufficient depth, width and length, a marking element having sufficient thickness, width and length having a marking surface having sufficient width and length.

2. The compact clip holder marking device attachment for measuring tape according to claim 1 wherein said one-piece clip holder having said top surface opening may receive in a downward direction a measuring tape and into said interior space area causing said one-piece clip holder and said measuring tape end to become attached by sufficient pressure by the said raised area located on the said interior back side causing the said measuring tape to be held in a fixed position in said one-piece clip holder.

3. The compact clip holder marking device attachment for measuring tape according to claim 1 wherein said one-piece clip holder having said bottom surface opening may receive in an upward direction into said interior space area said marking element having sufficient pressure against the interior surfaces of said interior space area causing said marking element to be held in a fixed position.

4. The compact clip holder marking device attachment for measuring tape according to claim 1 wherein by applying sufficient pulling force to said one-piece clip holder causing the disengagement of said measuring tape end from said one-piece clip holder.

5. The compact clip holder marking device attachment for measuring tape according to claim 1 wherein said one-piece clip holder may be used as a separate marking device.

6. The compact clip holder marking device attachment for measuring tape according to claim 1 by applying sufficient pulling force to said marking element causing the disengagement of said marking element from said one-piece clip holder allowing a replacement of said marking element.
